(19) United States
(12) Patent Application Publication
(10) Pub. No.: US 2004/0264031 A1
(43) Pub. Date: Dec. 30, 2004

(54) Method and apparatus for servo writing using incorporated servo writer in a disk drive

(75) Inventor: Masahide Yatsu, Akishima-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/804,111

(22) Filed: Mar. 19, 2004

(30) Foreign Application Priority Data
Jun. 30, 2003 (JP) 2003-188701

(51) Int. Cl. G11B 21/02; G11B 5/596

(52) U.S. Cl. 360/75; 360/77.04

(57) ABSTRACT

A method of servo writing is disclosed in which a servo writer incorporated in a disk drive writes a servo pattern into a disk medium. The servo writer controls positioning of a head on the basis of a basic servo pattern recorded on the disk medium to write a new servo pattern in the vicinity of the basic servo pattern. During this positioning control, the servo writer calculates a shape distortion of the basic servo patterns to correct a position of the head.

### CROSS-REFERENCE TO RELATED APPLICATIONS

This application is based upon and claims the benefit of priority from prior Japanese Patent Application No. 2003-188701, filed Jun. 30, 2003, the entire contents of which are incorporated herein by reference.

### BACKGROUND OF THE INVENTION

1. Field of the Invention

The present invention generally relates to disk drives, and in particular, to a method of servo writing using a servo writer incorporated in the disk drive.

2. Description of the Related Art

Disk drives represented by hard disk drives are generally configured to use a disk as a recording medium, and record data onto the disk with a magnetic head (head), or reproduce data from the disk.

In the disk drive, servo information called a servo pattern, which is used to position the head at a target position (target track position for reading/writing) on the disk, is recorded on the disk.

The servo patterns are written onto the disk in a servo writing step included in a manufacturing process of the disk drive. For a method of servo writing to write the servo patterns onto the disk, a transcription-type method for self-servo writing has been proposed (e.g., refer to Jpn. Pat. Appln. KOKAI Publication No. 1-208777), in addition to a method using a dedicated servo writer (servo track writer: also referred to as STW).

In this method for self-servo writing, a disk in which a base pattern has previously been recorded by the dedicated servo writer is incorporated in the disk drive. In the disk drive, the base pattern is used to control positioning of the head, and the servo patterns are written onto the disk.

In the method of self-servo writing described in the prior art technical document, as the base patterns previously recorded on the disk are used, writing accuracy of the base patterns influences accuracy of writing the servo patterns. Especially, such factors as rotation changes of the disk often distort a shape of the base patterns (track shape) written onto the disk. This could cause the self-servo writing to also distort a shape of the servo patterns written onto the disk.

### BRIEF SUMMARY OF THE INVENTION

In accordance with one embodiment of the present invention, there is provided a method of servo writing in a disk drive, wherein an incorporated servo writer is used to write, servo patterns whose shape distortion is corrected, into a disk medium.

The method comprises controlling the actuator mechanism on the basis of a basic servo pattern recorded on one disk surface of the disk medium, and performing a positioning control to position the head at a target position on the corresponding disk surface; calculating a shape distortion of the basic servo patterns with reference to an ideal shape; correcting a position of the head in accordance with a calculated shape distortion amount of the basic servo patterns; and writing a new servo pattern in the vicinity of the basic servo pattern on the disk surface of the disk medium with the head whose position is corrected.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a disk drive according to an embodiment of the present invention;

FIG. 2 is a block diagram showing a concept of a head positioning control system in a servo writer according to the present embodiment;

FIG. 3 is a diagram to explain a basic servo pattern and a new servo pattern according to the present embodiment;

FIGS. 4A and 4B are diagrams to explain an operation of writing the new servo pattern according to the present embodiment;

FIGS. 5 and 6 are diagrams to explain the operation of writing the new servo patterns into two disks in a method of servo writing according to the present embodiment;

FIGS. 7A and 7B are diagrams to explain a write correction function of the servo writer according to the present embodiment;

FIG. 8 is a block diagram showing a concept of the head positioning control system including a servo pattern shape estimation unit according to the present embodiment;

FIGS. 9 to 12 are diagrams to explain the write correction function of the servo writer according to the present embodiment;

FIG. 13 is a diagram to explain a principle of calculating a distortion amount of the basic servo patterns according to the present embodiment;

FIGS. 14 to 17 are diagrams to explain an operational principle of the servo pattern shape estimation unit according to the present embodiment; and

FIG. 18 is a flowchart to explain a procedure of an inspection process according to another present embodiment.

### DETAILED DESCRIPTION OF THE INVENTION

Embodiments of the present invention will hereinafter be described in reference to the drawings.

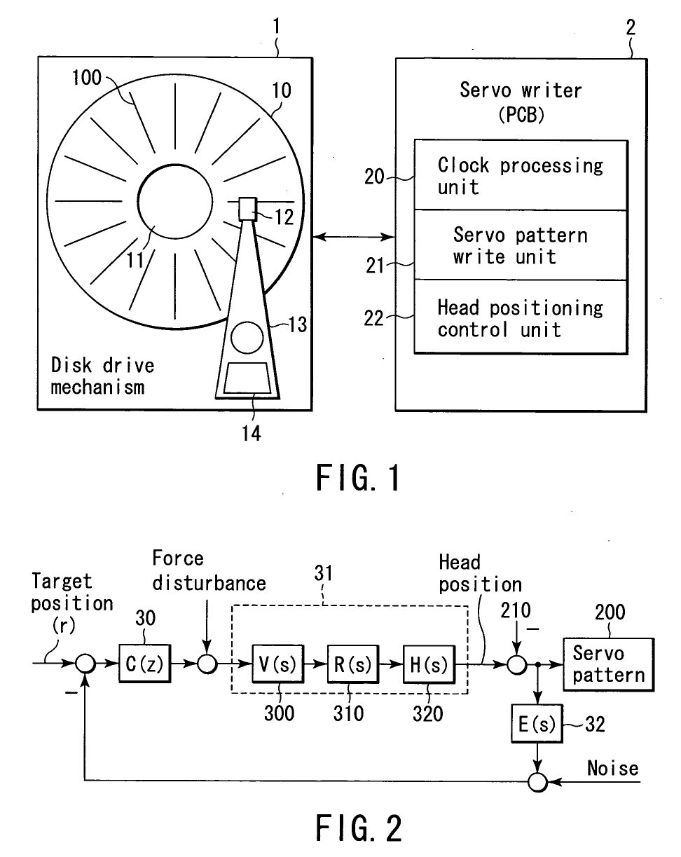

FIG. 1 is a block diagram showing a configuration of a disk drive to explain a method of servo writing according to the present embodiment.

(System Configuration)

As shown in FIG. 1, the disk drive of the present embodiment has a disk drive mechanism 1, and a print-circuit board (PCB) 2 mounted with a circuit group to enable a servo writer. In other words, the disk drive of the present embodiment is a type of disk drive in which the servo writer is incorporated.

The disk drive mechanism 1 has a disk 10 which is placed and rotated on a spindle motor (SPM) 11, and a head 12 mounted on an actuator 13.

The actuator 13 is a mechanism which is driven by a voice coil motor (VCM) 14 to move the head 12 in a radial direction on the disk 10.

In one surface of the disk 10, basic servo patterns (sometimes noted as BSP) 100 are recorded with predetermined spaces in a circumferential direction by an ordinary dedicated servo writer (STW). The basic servo pattern 100 has the same contents as an ordinary servo pattern, and has a cylinder address (track address codes) and a servo burst signal.

Furthermore, the disk 10 comprises one or two or more disk plates, and has two or more data recording surfaces. The basic servo pattern 100 is recorded only in one data surface regardless of the number of disk plates.

The head 12 is equipped with a read head element for performing a read operation and a write head element for performing a write operation on the same slider. In the head 12, the read head element reads the basic servo pattern 100 from the disk 10. Further, the write head element writes a new servo pattern described later onto the disk 10.

In the present embodiment, the PCB and the circuit group to enable a servo writer function are collectively expressed as a servo writer 2 for convenience. The servo writer 2 is comprised of a microprocessor (CPU), a memory storing a program to enable the servo writer function, a VCM driver to drive a VCM 14, a read/write channel to process a read/write signal of the head 12, and the like.

The servo writer 2 enables functions of roughly a clock processing unit 20 for generating various kinds of clocks, a servo pattern write unit 21, and a head positioning control unit 22.

The clock processing unit 20 enables a clocking function to decide write timing for writing the new servo pattern. More specifically, the clock processing unit 20 decides the write timing in a disk rotation direction on the basis of the basic servo patterns read by the head 12 (read head element). The servo pattern write unit 21 supplies a servo signal for writing the new servo pattern onto the disk 10 with the head 12 (write head element).

The head positioning control unit 22 controls the actuator 13 (actually the VCM 14) on the basis of the basic servo patterns read by the head 12 (read head element) to control positioning of the head 12. In other words, the head positioning control unit 22 performs a head positioning operation in a radial direction of the disk 10.

In addition, the present embodiment does not require a positioner which is an external positioning mechanism, and a clock head. Moreover, the disk drive operates in a sealed state in which the servo writer 2 is incorporated, thus requiring no clean room.

Furthermore, the servo writer 2 can delete a program stored in the memory mounted on the PCB after writing the new servo pattern to remove the program from the disk drive which has become a commercial product.

(Head Positioning Control System)

The head positioning control unit 22 included in the servo writer 2 conceptually comprises a feedback control system as shown in FIG. 2.

This system is roughly comprised of a controller 30 (transfer function C (z)), a broad control target 31, and a position sensor 32 (transfer function E (s)).

The control target 31 includes a narrow plant 300 (transfer function V (s)), a plant 310 (transfer function R (s)), and a plant 320 (transfer function H (s)). The plants plant 300, 310 and 320 respectively correspond to the VCM 14, the actuator 13, and the slider mounted with the head 12 of the disk drive.

The position sensor 32 detects and feeds back a position of the head 12 (actually the slider) included in the control target 31 whose drive is controlled in accordance with a controlled manipulated variable from the controller 30.

The controller 30 calculates the controlled manipulated variable so as to resolve a positional error between a target position (r) of the head 12 and a relative position (actually including noise) observed by the position sensor 32.

The head 12 positioned by such a system writes a new servo pattern 200 onto the disk 10. Here, the position of the head 12 is detected on the basis of the basic servo patterns recorded on the disk 10, but is affected by shape distortion of the basic servo patterns.

(Method of Servo Writing)

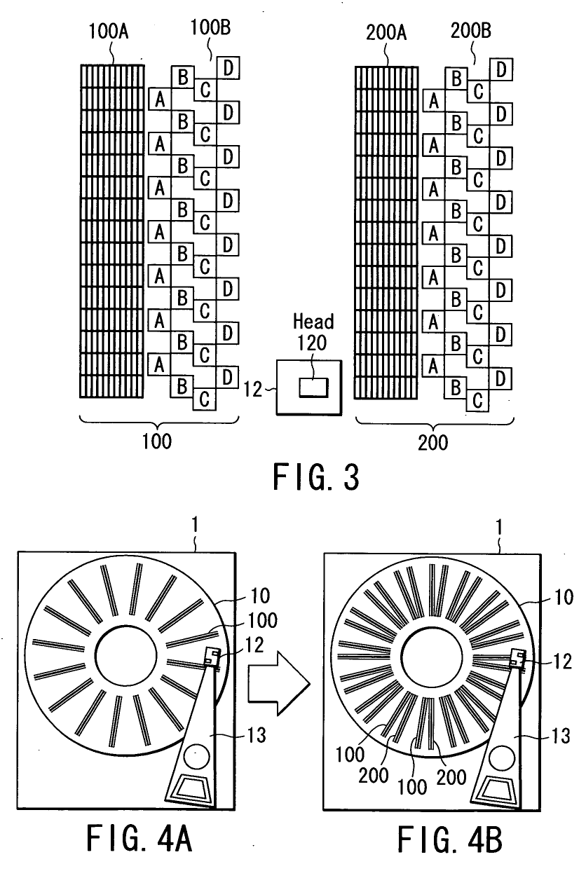

As shown in FIG. 3, the basic servo pattern 100 is roughly divided into a preliminary stage section 100A such as the cylinder address, and a subsequent stage section 100B such as a burst servo pattern. The cylinder address is information to identify a track position on a disk surface. Further, the servo burst pattern is information to find a detail position in each track.

In addition, FIG. 3 shows a positional relationship among the basic servo pattern 100, the new servo pattern 200 and the head 12. Here, the head 12 means the slider, and is equipped with a read/write head element (actually separated) 120.

As shown in FIG. 3, the servo writer 2 of the present embodiment executes the positioning operation of the head 12 on the basis of the basic servo pattern 100 read by the head 12, and writes the new servo pattern 200. The new servo pattern 200 is roughly separated into a preliminary stage section 200A such as the cylinder address, and a subsequent stage section 200B such as the burst servo pattern, basically similarly to the basic servo pattern 100.

Before a write operation of the servo writer 2, the basic servo patterns 100 are radially recorded on the data surface of the disk 10, as shown in FIG. 4A. By the write operation of the servo writer 2, the new servo patterns 200 are recorded in the vicinity of (adjacent to) the basic servo patterns 100 on the data surface of the disk 10, as shown in FIG. 4B.

Here, for convenience, two disks including a first disk and a second disk are provided as a plurality of disks 10 on the SPM 11 of the disk drive mechanism 1 of the present embodiment.

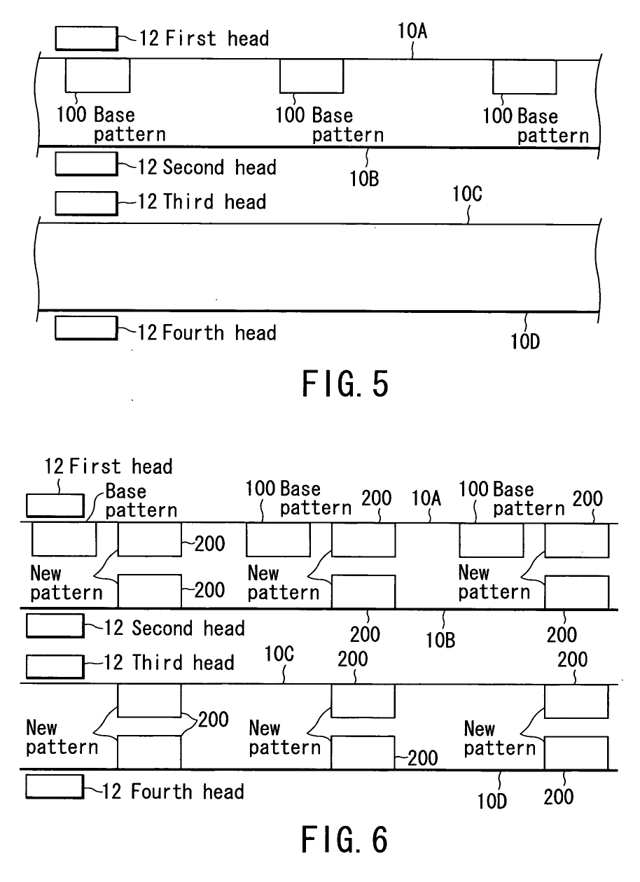

As shown in FIG. 5 and FIG. 6 (laterally viewed conceptual diagrams), the first disk has a disk surface 10A in which the basic servo patterns 100 are recorded, and a disk surface 10B which is a rear surface thereof. Further, the second disk (raw disk) in which the basic servo patterns 100 are not recorded has disk surfaces 10C and 10D.

In the disk drive mechanism 1, the first to fourth heads 12 corresponding to the disk surfaces 10A to 10D are mounted on the same actuator 13, and are configured to simultaneously move in a radial direction.

More specifically, as shown in FIG. 5, by reading the basic servo pattern 100 with the first head 12, the servo writer 2 simultaneously positions the first to fourth heads 12 at the target positions (positions where the new servo patterns are to be recorded). The servo writer 2 supplies the servo signals to the first to fourth heads 12 to write the new servo patterns 200 into all the disk surfaces 10A to 10D, as shown in FIG. 6.

Here, the servo writer 2 can use the recorded new servo patterns 200 to control the positioning of the heads 12. Because the basic servo patterns 100 are not necessary after the new servo patterns 200 have been written into the disk surfaces 10A to 10D, the servo writer 2 may delete the basic servo patterns 100.

However, the basic servo patterns 100 may be left to omit a step of deleting the basic servo patterns 100. In this case, the basic servo patterns 100 will be deleted by being overwritten when user data is recorded, after the disk drive is shipped as a product. In a read/write operation of the user data, the positioning of the head 12 is controlled, naturally on the basis of the new servo patterns 200.

(Write Correction Function of the Servo Writer)

The servo writer 2 of the present embodiment basically uses the basic servo patterns 100 previously recorded on the disk 10 as described above to control the positioning of the head 12, and writes the new servo patterns 200.

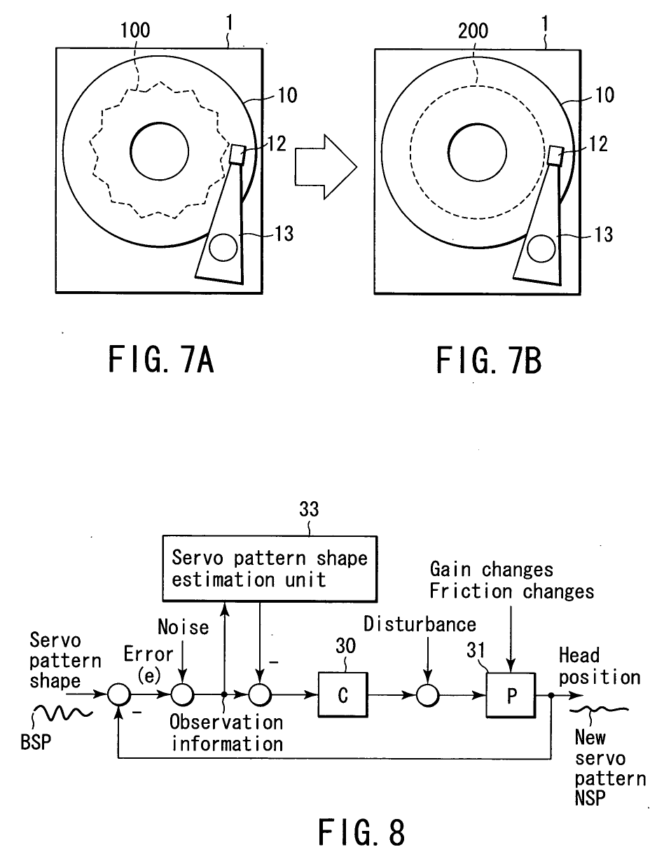

Here, as shown in FIG. 7A, the basic servo patterns 100 often cause the pattern shape distortion due to effects of disturbance when written by the dedicated servo writer (STW). Therefore, when the servo writer 2 uses the basic servo patterns 100 to write the new servo patterns 200, the effects of the pattern shape distortion reduce writing accuracy.

The servo writer 2 of the present embodiment uses the following write correction function to compensate for the effects of the shape distortion of the basic servo patterns 100, thereby writing the new servo patterns 200 having an almost circular shape as shown in FIG. 7B.

FIG. 8 is a block diagram showing a head positioning control system including a servo pattern shape estimation unit 33 to enable the write correction function in the head positioning control unit 22 included in the servo writer 2 of the present embodiment.

As shown in FIG. 8, the system is subjected to plural kinds of disturbance components during the head positioning operation. More specifically, the controller 30 is subjected to an observation noise for a positional error e with reference to the target position. The control target 31 including the actuator 13 is subjected to disturbance elements typified by acceleration disturbance and disturbance elements such as gain changes and friction changes.

Here, the servo writer 2 can not directly observe the pattern shape of the basic servo patterns 100 recorded on the disk 10. The servo writer 2 can detect observation information that is a component in which noise is added to the relative position (position of the basic servo pattern) with the head position observed by the position sensor 32.

The servo pattern shape estimation unit 33 inputs the observation information (i.e., the positional error value e to which the noise is added) to calculate (estimate) the shape distortion of the basic servo patterns, and adds it as a correction value to an input of the controller 30.

If a result of the servo pattern shape estimation unit 33 corresponds to the pattern shape of the basic servo patterns 100, they deny each other on the transfer function, so that the controller 30 can correct a deviation of the head position.

(Configuration and Operational Principle of the Pattern Shape Estimation Unit)

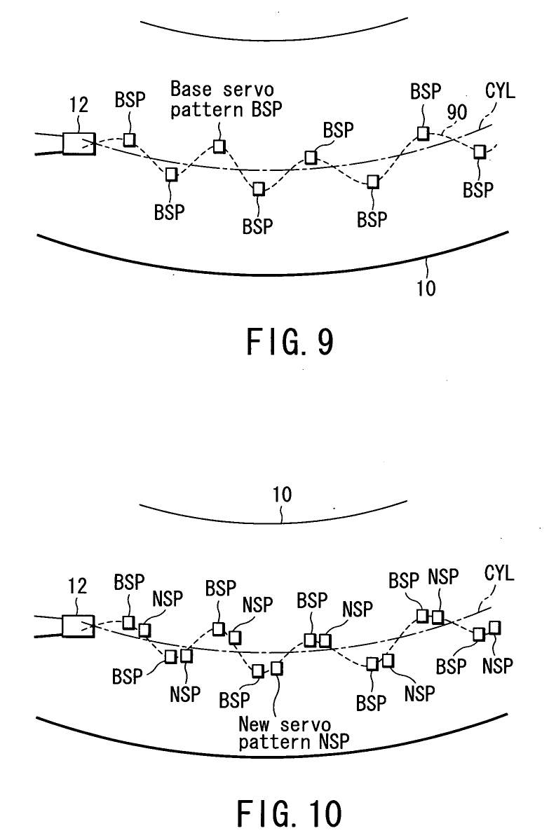

First, the write correction function by the servo writer 2 including the pattern shape estimation unit 33 will be roughly described referring to FIG. 9 to FIG. 12.

FIG. 9 is a diagram showing the basic servo patterns BSP recorded in a distorted state with reference to an ideal position of the servo patterns (CYL, i.e., a centerline of the cylinder). If the servo writer 2 accurately leads the head 12 on the basis of the basic servo patterns BSP, a head movement track 90 will be as shown in FIG. 9.

If the servo writer 2 writes the new servo pattern NSP on the basis of the basic servo pattern BSP, the new servo pattern NSP will be written at a position deviated from the ideal position CYL, as shown in FIG. 10. To be brief, when the basic servo patterns BSP have the shape distortion, the new servo patterns NSP can not be written at the ideal position even if the head 12 accurately follows the basic servo patterns BSP.

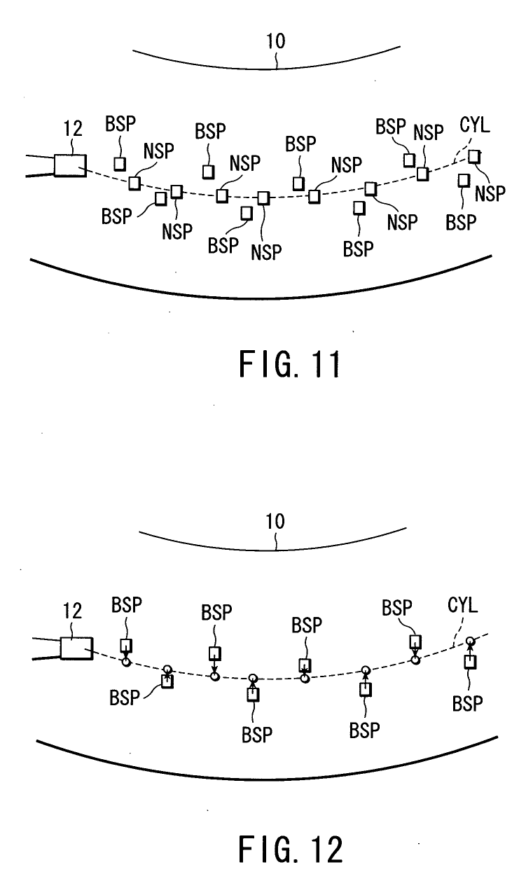

Even if the basic servo patterns 100 (BSP) have the shape distortion, the servo writer 2 of the present embodiment can correct the movement track of the head to the ideal position CYL to write the new servo patterns NSP in the ideal position as shown in FIG. 11.

In other words, the servo writer 2 has the head positioning control unit 22 (system of FIG. 8) including the servo pattern shape estimation unit 33 as a correcting function to correct the movement track of the head 12 to the ideal position CYL.

More specifically, the system calculates (estimates) a distortion amount (i.e., position correcting amount) of the basic servo patterns BSP to correct the movement track of the head 12 to the ideal position CYL in accordance with the distortion amount, as shown in FIG. 12.

The servo writer 2 can use the distortion amount (position correcting amount) of the basic servo patterns BSP so that the ideal position CYL will be a target position for leading the head 12, thereby writing the new servo patterns NSP in the ideal position, as shown in FIG. 11.

Here, the position correcting amount in the positioning control of the head 12 equals to the distortion amount of the basic servo patterns (pattern shape distortion amount), as shown in FIG. 12. Therefore, the servo pattern shape estimation unit 33 comprises a function to calculate the distortion amount of the basic servo patterns BSP.

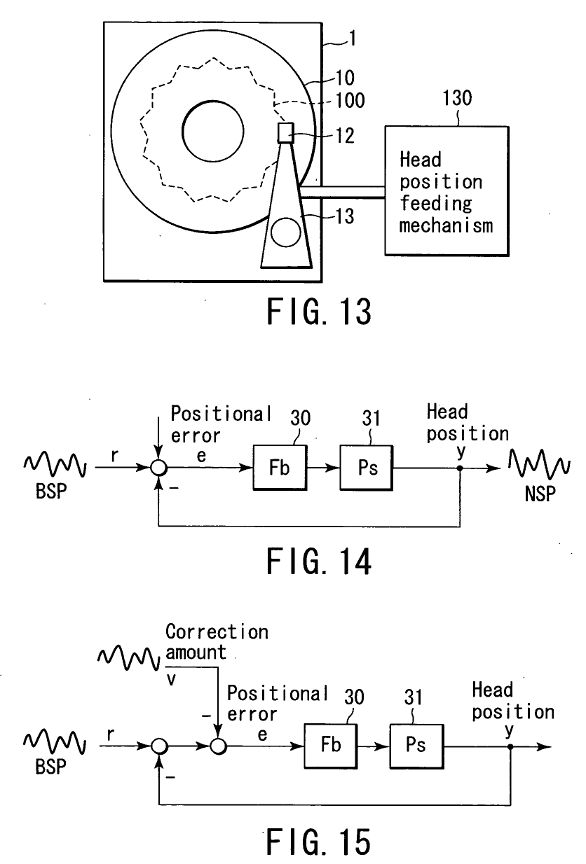

A method of directly obtaining the distortion amount of the basic servo patterns includes moving the actuator 13 equipped with the head 12 to a desired position by a head position feeding mechanism 130 provided in an external unit of the disk drive, so as to fix the head 12 at that position, as shown in FIG. 13. This method also includes calculating the distortion amount of the basic servo patterns on the basis of the basic servo patterns read from the head 12.

However, in this method, the head position feeding mechanism 130 is provided outside the disk drive, and this can not ensure the sealed state of the disk drive, thus requiring a clean environment such as a clean room. Further, the head position feeding mechanism 130 is naturally needed in addition to the disk drive mechanism 1, posing a number of problems in cost and operating efficiency.

Referring to FIG. 14 to FIG. 17, the operational principle of the servo pattern shape estimation unit 33 of the present embodiment will be described below.

First, FIG. 14 shows the feedback control system also employed in the head positioning control unit (22) of the present embodiment. Here, a relational expression between a target position r of the head obtained from the basic servo pattern BSP and a controlled head position y is obtained by a transfer function, thereby resulting in the following Equation (1).

$$y = \frac{Fb \cdot Ps}{1 + Fb \cdot Ps} r \qquad ( 1 )$$

FIG. 15 shows the system to which a correction amount v is added, which results in the following Equation (2).

$$y = \frac{Fb \cdot Ps}{1 + Fb \cdot Ps} ( r - v ) = 0 \qquad ( 2 )$$

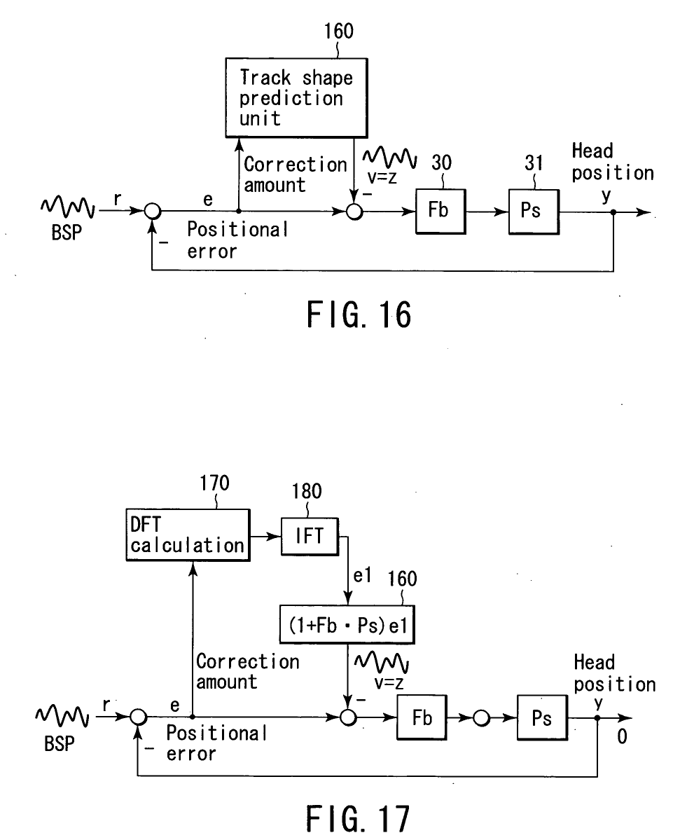

Here, the system can observe only the positional error e, as described above. FIG. 16 shows the system to which a track shape prediction unit 160 for predicting a track shape (i.e., basic servo pattern shape) from the positional error e is added. In this case, Relational expression (3) will be as follows:

$$y = \frac{Fb \cdot Ps}{1 + Fb \cdot Ps} ( r - z ) = 0 \qquad ( 3 )$$

The track shape prediction unit 160 calculates Relational expressions (4) and (5) between the target position r and the positional error e.

$$\begin{matrix}e = \frac{1}{1 + Fb \cdot Ps} r & ( 4 ) \\ r = ( 1 + Fb \cdot Ps ) e & ( 5 )\end{matrix}$$

Here, Relational expression (4) is referred to as a sensitivity closed-loop function, and Relational expression (5) shows a counter-model of the sensitivity closed-loop function. The track shape prediction unit 160 can thus estimate the track shape from Relational expression (5). Here, as shown in FIG. 16, z indicates an estimate of a track shape r, and is used as the correction amount v.

In FIG. 17, the system has a DFT (discrete Fourier transform) calculation unit 170 and an inverse Fourier transform calculation unit (IFT) 180 which extract a particular frequency component from the positional error e, and an element to input calculation results of the inverse Fourier transform calculation unit 180 to the track shape prediction unit 160 is added to the system. In this case, the DFT calculation unit 170 performs calculations indicated by the following Relational expressions (6), (7) and (8)

$$\begin{matrix}\begin{matrix}e ( t ) = {a}_{1} sin \frac{2 π}{T} t + {a}_{2} sin 2 \frac{2 π}{T} t + {a}_{3} sin 3 \frac{2 π}{T} t + … + \\ {b}_{1 } cos \frac{2 π}{T} t + {b}_{2} cos 2 \frac{2 π}{T} t + {b}_{3} cos 3 \frac{2 π}{T} t + … + \\ \frac{1}{2} {c}_{0}\end{matrix} & ( 6 ) \\ \begin{matrix}\begin{matrix}{a}_{n} = \frac{2}{T} {\int }_{- \frac{T}{2}}^{\frac{T}{2}} e ( t ) sin n \frac{2 π}{T} t ⅆ t \\ {b}_{n} = \frac{2}{T} {\int }_{- \frac{T}{2}}^{\frac{T}{2}} e ( t ) cos n \frac{2 π}{T} t ⅆ t\end{matrix} \\ {c}_{0} = \frac{2}{T} {\int }_{- \frac{T}{2}}^{\frac{T}{2}} e ( t ) ⅆ t\end{matrix} \} & ( 7 ) \\ \begin{matrix}{a}_{m} = \frac{2 Ts}{nT} {\sum }_{i = 1}^{\frac{nT}{Ts}} e ( i ) sin \frac{2 π m}{T} t ( i ) \\ {b}_{m} = \frac{2 Ts}{nT} {\sum }_{i = 1}^{\frac{nT}{Ts}} e ( i ) cos \frac{2 π m}{T} t ( i )\end{matrix} \} & ( 8 )\end{matrix}$$

Here, Ts indicates sampling time. T indicates time for one rotation of the SPM 11. e indicates the positional error. n indicates a learning rotation number. m indicates an eccentric order.

Furthermore, the inverse Fourier transform calculation unit 180 shown in FIG. 17 executes an inverse Fourier transform calculation based on a DFT calculation result of the particular frequency obtained by Equation (8) above, thereby making it possible to extract a particular frequency component e1 contained in the positional error.

If this calculation result is substituted for the following Equation (9) similarly to Equation (5) above, only the particular frequency component can be corrected.

z=(1+Fb−Ps)e1 (9)

As described above, the servo writer 2 of the present embodiment executes such a correction that the head positioning control unit 22 including the servo pattern shape estimation unit 33, which calculates (estimates) the distortion amount (position correcting amount) of the basic servo patterns 100, leads the head 12 to the ideal position CYL on the disk 10. Thus, the new servo patterns NSP can be written into the ideal position CYL, as shown in FIG. 11.

In other words, as shown in FIGS. 7A and 7B, the shape distortion of the basic servo patterns 100 is calculated, and by compensating its effects, the new servo patterns 200 can be written in an almost circular shape as a result.

(Another Embodiment)

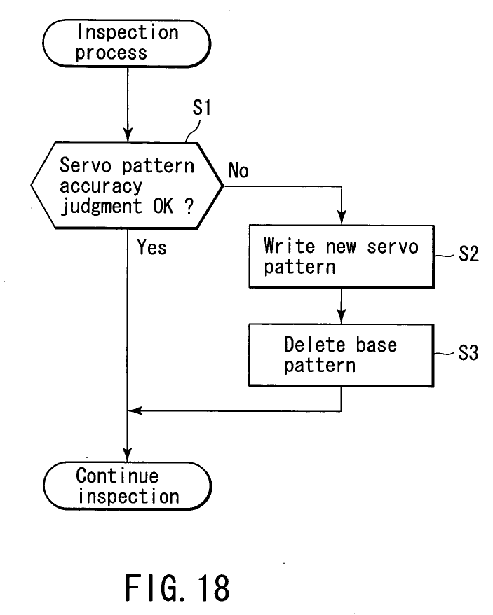

FIG. 18 is a flowchart according to another alternative embodiment.

This shows how the method of servo writing of the present embodiment is applied in an inspection process included in a manufacturing process of the disk drive. Referring to the flowchart of FIG. 18, this will be specifically described below.

First, in the inspection process, the basic servo pattern 100 recorded on the disk 10 is used to check whether or not the disk drive operates properly. At this moment, the writing accuracy of the basic servo pattern 100 is measured, and if a measured result does not reach a stipulated value, the inspection process will be interrupted (NO of step S1).

At this point, the servo writer 2 of the present embodiment is started, and writes the new servo patterns 200 onto the disk 10 as described above (step S2). Then, the servo writer 2 deletes the basic servo patterns 100 whose writing accuracy does not reach the stipulated value (step S3).

As described above, the disk drives, which have conventionally been inspected and treated as defective products because of the decreased writing accuracy of the basic servo patterns, can be shipped as non-defective products by rewriting with the new servo patterns.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A method of servo writing using an incorporated servo writer in a disk drive which includes a disk medium, a head corresponding to a disk surface of the disk medium, and an actuator mechanism mounted with the head, the method comprising:
controlling the actuator mechanism on the basis of a basic servo pattern recorded on one disk surface of the disk medium, and performing a positioning control to position the head at a target position on the corresponding disk surface;
calculating a shape distortion of the basic servo patterns with reference to an ideal shape;
correcting a position of the head in accordance with a calculated shape distortion amount of the basic servo patterns; and
writing a new servo pattern in the vicinity of the basic servo pattern on the disk surface of the disk medium with the head whose position is corrected.

2. A method according to claim 1, further comprising:
observing a positional error value (e) between the target position and a current position of the head during the positioning control; and
calculating a shape of the basic servo patterns by use of the positional error value (e);
wherein
the shape distortion of the basic servo patterns with reference to the ideal shape is calculated in accordance with the calculated shape of the basic servo patterns.

3. A method according to claim 1, further comprising:
overwriting user data with the head whose positioning is controlled on the basis of the new servo pattern to delete the basic servo pattern.

4. A method according to claim 1, further comprising:
deleting the basic servo pattern after the new servo pattern is written.

5. A method according to claim 1, wherein:
the disk medium has a first data surface in which the basic servo pattern is recorded and a second data surface in which the basic servo pattern is not recorded,
the actuator mechanism is equipped with a first head corresponding to the first data surface and a second head corresponding to the second data surface, and simultaneously positions the first and second heads,
the actuator mechanism is controlled on the basis of the basic servo patterns read by the first head corresponding to the first data surface, and
the new servo patterns are simultaneously written into the first data surface and the second data surface.

6. A method according to claim 1, further comprising:
measuring writing accuracy of the basic servo pattern; and
writing the new servo pattern on the basis of the measurement when the writing accuracy is out of an allowable range.

7. A disk drive comprising:
a disk medium having a data surface in which a servo pattern is recorded;
a head for writing and reading data including the servo pattern in and from the data surface;
an actuator mechanism mounted with the head which moves the head in a radial direction of the disk surface; and
a servo writer for writing the servo pattern into the disk medium,
wherein the servo writer includes:
means for controlling the actuator mechanism on the basis of a basic servo pattern recorded on one disk surface of the disk medium, and performing a positioning control to position the head at a target position on the corresponding disk surface;
means for calculating a shape distortion of the basic servo patterns with reference to an ideal shape in accordance with a shape of the basic servo patterns;
means for correcting a position of the head in accordance with a shape distortion amount of the basic servo patterns; and
means for writing a new servo pattern in the vicinity of the basic servo pattern on the disk surface with the head whose position is corrected.

8. The disk drive according to claim 7, wherein:
the servo writer includes:
a unit for positioning the head at the target position on the disk medium on the basis of the basic servo pattern read by the head;
a unit for deciding timing in a rotation direction of the disk surface; and
a unit for writing the new servo pattern.

9. The disk drive according to claim 7, wherein:
the servo writer has a microprocessor and a memory storing a program, and is configured to enable servo writing by causing the microprocessor to execute the program.

10. The disk drive according to claim 7, wherein:
the servo writer includes:
means for observing a positional error value between the target position and a current position of the head during the positioning control; and
means for calculating the shape of the basic servo patterns by use of the positional error value.

11. The disk drive according to claim 7, wherein:
in the disk medium,
the basic servo pattern and the new servo pattern coexist on the data surface in which the basic servo pattern has been recorded, after the new servo pattern is recorded by the servo writer.

12. The disk drive according to claim 7, wherein:
in the disk medium,
the basic servo pattern is deleted after the new servo pattern is recorded by the servo writer.

13. The disk drive according to claim 7, wherein:
in the disk medium,
user data is overwritten by the head to delete the basic servo pattern totally or in part, after the new servo pattern is recorded by the servo writer.

14. The disk drive according to claim 7, wherein:
the disk medium has a first data surface in which the basic servo pattern is recorded and a second data surface in which the basic servo pattern is not recorded,
the actuator mechanism is equipped with a first head corresponding to the first data surface and a second head corresponding to the second data surface, and simultaneously moves the first and second heads, and
the servo writer
controls the actuator mechanism on the basis of the basic servo patterns read by the first head corresponding to the first data surface, and
simultaneously writes the new servo patterns into the first data surface and the second data surface.
